(19) United States
(12) Patent Application Publication
(10) Pub. No.: US 2005/0275765 A1
(43) Pub. Date: Dec. 15, 2005

(54) Light source and liquid crystal display device having the same

(75) Inventors: Hyeon-Yong Jang, Osan-si (KR); Hyoung-Joo Kim, Uiwang-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/141,921

(22) Filed: Jun. 1, 2005

(30) Foreign Application Priority Data
Jun. 9, 2004 (KR) 2004-42198

(51) Int. Cl. G02F 1/1335

(52) U.S. Cl. 349/62

(57) ABSTRACT

A light source for generating a planar light includes a first substrate, a second substrate and a first external electrode. The second substrate includes a plurality of discharge space portions, a plurality of space dividing portions and a plurality of recesses formed on end portions of a predetermined number of the discharge space portions. The discharge space portions are spaced apart from the first substrate to form a plurality of discharge spaces. The space dividing portions make contact with the first substrate between the discharge space portions. The recesses are recessed toward the first substrate. The first external electrode is formed on the second substrate. Therefore, a luminance of the planar light is uniformized to improve an image display quality.

### CROSS-REFERENCE TO RELATED APPLICATION

The present application claims priority from Korean Patent Application No. 2004-42198, filed on Jun. 9, 2004, the disclosure of which is hereby incorporated herein by reference in its entirety.

### BACKGROUND OF THE INVENTION

1. Technical Field

The present disclosure relates to a light source and a liquid crystal display (LCD) device having the light source. More particularly, the present invention relates to a light source for generating a planar light and an LCD device having the light source.

2. Discussion of the Related Art

An LCD device is a flat panel display device. The LCD device displays an image using liquid crystal. The LCD device has various characteristics such as light weight, low driving voltage, low power consumption, etc. Accordingly, the LCD device has been widely used in various fields.

The LCD device is a non-emissive type display device that may include a backlight assembly that generates a light.

The backlight assembly can include a cold cathode fluorescent lamp (CCFL). The backlight assembly is classified into an edge illumination type or a direct illumination type. In the edge illumination type, the backlight assembly includes a light guiding plate and one or two light sources adjacent to a side surface of the light guiding plate so that the light generated from the light sources is guided into an LCD panel of the LCD device. In the direct illumination type, the backlight assembly includes a plurality of light sources under the LCD panel and a diffusion plate between the LCD panel and the light sources so that the light generated from the light sources is diffused and irradiated into the LCD panel.

When the backlight assembly includes the light guiding plate or the diffusion plate, size and weight of the LCD device increase. In addition, a luminance of the backlight assembly decreases, and luminance uniformity is deteriorated. Furthermore, the backlight assembly has a complicated structure so that a manufacturing cost of the LCD device increases.

A light source for generating a planar light has been developed to overcome these problems. The light source includes an upper substrate, a lower substrate, an electrode and a plurality of discharge spaces between the upper and lower substrates. When a voltage is applied to the electrode, a plasma discharge is generated in the discharge spaces to generate light.

In operation of the light source, a luminance of outer discharge spaces that are on upper and lower portions of the light source is less than that of central discharge spaces on central portion of the light source. When the light source is combined with other elements such as a receiving container, luminance difference between the outer discharge spaces and the central discharge space increases. Therefore, the luminance uniformity and an image display quality of the LCD device are deteriorated.

### SUMMARY OF THE INVENTION

A light source is provided for generating a planar light having uniform luminance.

An LCD device having the above-mentioned light source, is capable of improving an image display quality.

A light source for generating a planar light in accordance with an embodiment of the present invention includes a first substrate, and a second substrate. The first substrate has a flat or plate shape. The second substrate includes a plurality of discharge space portions, a plurality of space dividing portions and a plurality of recesses formed on a predetermined number of the discharge space portions. The discharge space portions are spaced apart from the first substrate to form a plurality of discharge spaces. The space dividing portions make contact with the first substrate between the discharge space portions.

The recesses may be formed on end portions of the discharge space portions and recessed toward the first substrate. A first external electrode may be formed on the second substrate.

A light source for generating a planar light in accordance with an embodiment of the present invention includes a first substrate, and a second substrate. The first substrate has a flat or plate shape. The second substrate includes a plurality of discharge space portions, a plurality of space dividing portions and a plurality of protrusions formed on a predetermined number of the discharge space portions. The discharge space portions are spaced apart from the first substrate to form a plurality of discharge spaces. The space dividing portions make contact with the first substrate between the discharge space portions.

The protrusions may be formed on end portions of the predetermined number of discharge space portions and protruded toward the first substrate.

An LCD device in accordance with an embodiment of the present invention includes a light source for generating a planar light, a liquid crystal display panel and an inverter. The light source includes a first substrate, a second substrate and a first external electrode. The first substrate has a flat or plate shape. The second substrate has a plurality of discharge space portions, a plurality of space dividing portions and a plurality of luminance increasing parts formed on end portions of a predetermined number of the discharge space portions. The discharge space portions are spaced apart from the first substrate to form a plurality of discharge spaces. The space dividing portions make contact with the first substrate between the discharge space portions. The first external electrode is formed on the second substrate. The first external electrode is extended in a direction substantially perpendicular to a longitudinal direction of the discharge space portions to be overlapped with the end portions of the discharge space portions and the luminance increasing parts. The liquid crystal display panel displays an image using the planar light generated from the light source. The inverter applies a discharge voltage to the first external electrode to drive the liquid crystal display panel.

Therefore, the light source includes a luminance increasing part such as a recess or a protrusion so that the luminance of the planar light is uniformized, and the image display quality of the LCD device is improved.

### BRIEF DESCRIPTION OF THE DRAWINGS

Preferred embodiments of the present invention can be understood in more detail from the following descriptions taken in conjunction with the accompanying drawings, in which:

FIG. 1 is a perspective view showing a light source for generating planar light in accordance with an exemplary embodiment of the present invention;

FIG. 2 is a cross-sectional view taken along a line I-I′ of FIG. 1;

FIG. 3 is a perspective view showing a rear face of the light source of FIG. 1;

FIG. 4 is a plan view showing the light source of FIG. 1;

FIG. 5 is a cross-sectional view taken along a line II-II′ of FIG. 4;

FIG. 6 is an enlarged plan view showing a recess of FIG. 4;

FIG. 7 is a cross-sectional view showing a line III-III′ of FIG. 6;

FIG. 8 is a cross-sectional view showing a light source in accordance with an exemplary embodiment of the present invention;

FIG. 9 is an enlarged perspective view showing a portion D of FIG. 1;

FIG. 10 is a cross-sectional view taken along a line V-V′ of FIG. 9; and

FIG. 11 is an exploded perspective view showing a liquid crystal display (LCD) device in accordance with an exemplary embodiment of the present invention.

### DETAILED DESCRIPTION OF THE PREFERRED EMBODIMENTS

Preferred embodiments of the present invention will be described below in more detail with reference to the accompanying drawings. This invention may, however, be embodied in different forms and should not be construed as limited to the embodiments set forth herein. Rather, these embodiments are provided so that this disclosure will be through and complete, and will fully convey the scope of the invention to those skilled in the art.

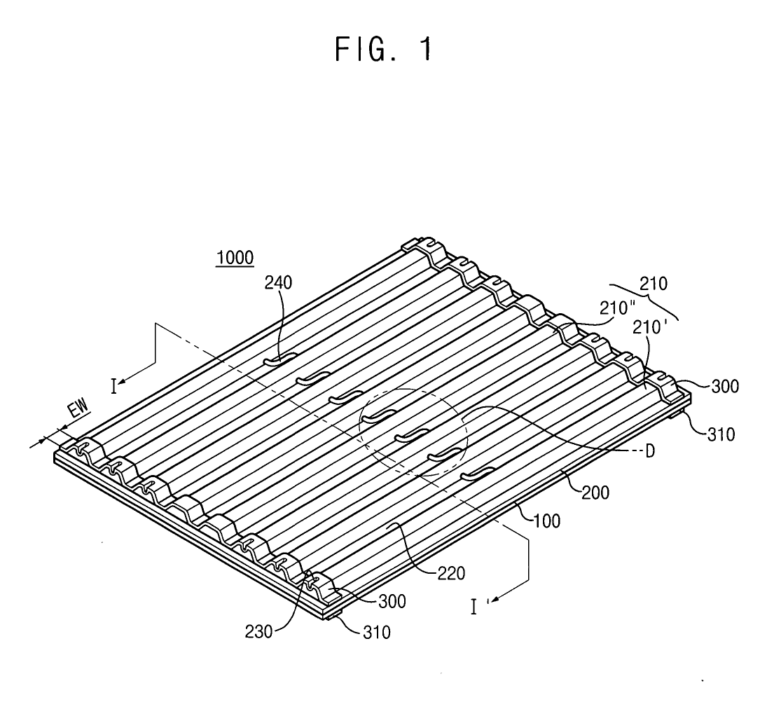

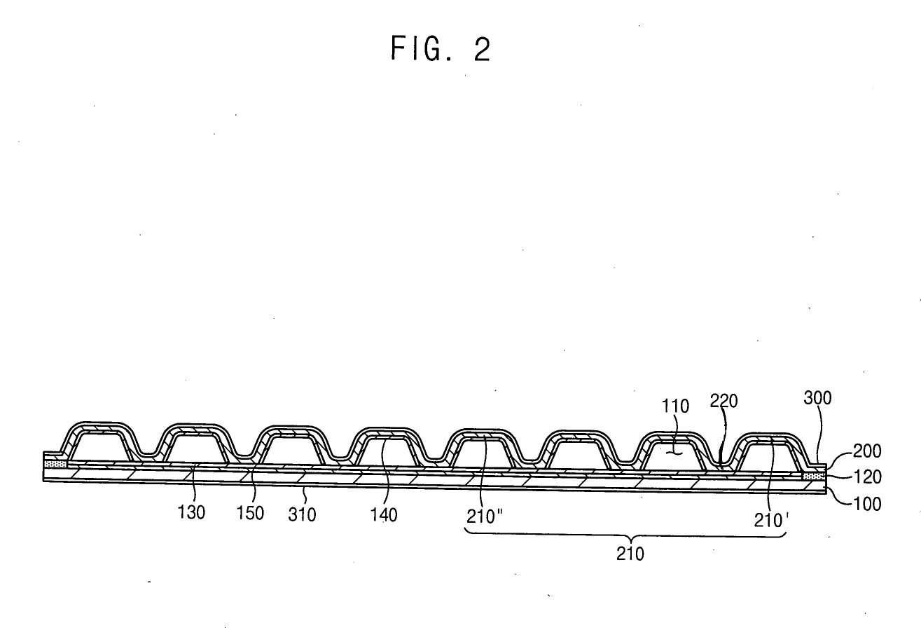

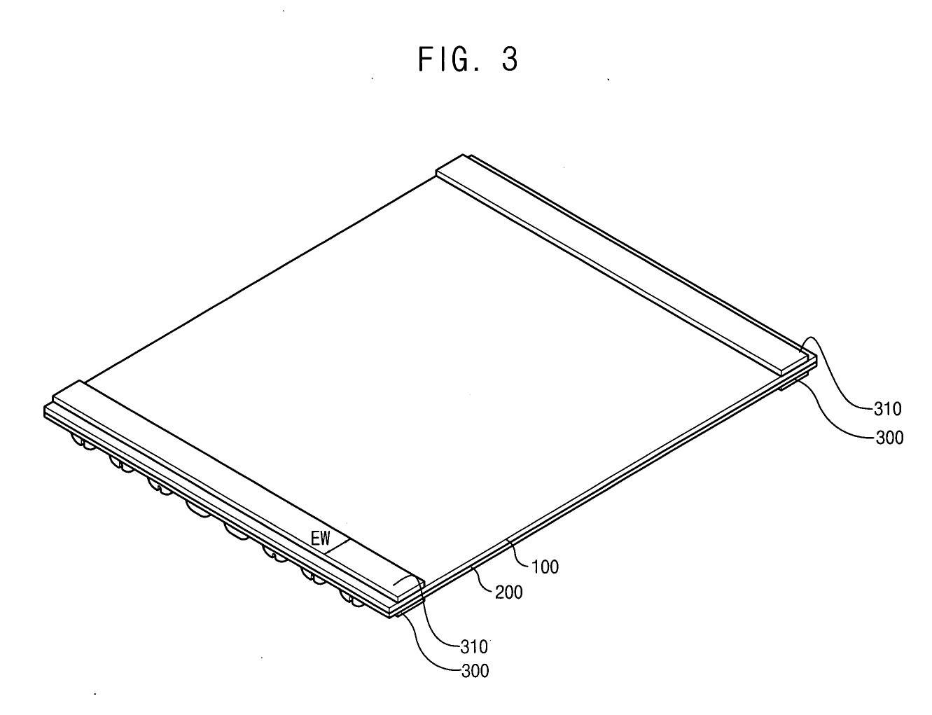

FIG. 1 is a perspective view showing a light source for generating planar light in accordance with an exemplary embodiment of the present invention. FIG. 2 is a cross-sectional view taken along a line I-I′ of FIG. 1. FIG. 3 is a perspective view showing a rear face of the light source of FIG. 1.

Referring to FIGS. 1 to 3, the light source 1000 includes a first substrate 100, a second substrate 200 and a first external electrode 300.

The first substrate 100 has a flat quadrangular shape. In this exemplary embodiment, the first substrate 100 is a glass substrate that blocks an ultraviolet light, through which a visible light may pass through.

The second substrate 200 is combined with the first substrate 100 to form a plurality of discharge spaces 110 between the first and second substrates 100 and 200. In this exemplary embodiment, the second substrate 200 is a glass substrate that includes substantially the same material as the first substrate 100. The second substrate 200 includes a plurality of discharge space portions 210 and a plurality of space dividing portions 220. The discharge space portions 210 are spaced apart from the first substrate 100 to form the discharge spaces 110. The space dividing portions 220 are positioned on the first substrate 100 between the discharge space portions 210, and make contact with the first substrate 100. The first substrate 100 includes a first fluorescent layer 130 and a reflecting layer 150 disposed thereon (described further below). Each of the space dividing portions 220 is formed between the adjacent discharge space portions 210 to form each of the discharge spaces 110.

The discharge space portions 210 include outer discharge space portions 210′ and central discharge space portions 210″. The outer discharge space portions 210′ are adjacent to an upper side or a lower side of the light source 1000. Referring to FIG. 1, each of the outer discharge space portions 210′ includes a luminance increasing part 230. The luminance increasing part 230 may be a recess or a protrusion. A contact area between the first substrate 100 and the first external electrode 300 is increased by the luminance increasing part 230 so that an amount of a current that flows through each of the discharge spaces 110 increases, thereby increasing the luminance of the light generated in each of the discharge spaces 110.

In this exemplary embodiment, the second substrate 200 is formed through a molding process. That is, a glass plate is heated and pressed to form the second substrate 200 having the discharge space portions 210, the space dividing portions 220 and the luminance increasing parts 230. Alternatively, the second substrate 200 may be formed through a blow molding process. In the blow molding process, the glass plate is heated and compressed by air to form the second substrate 200.

A cross-section of the second substrate 200 includes a plurality of trapezoidal shapes that are connected to one another. The trapezoidal shapes have rounded corners, and arranged substantially in parallel. Alternatively, the cross-section of the second substrate 200 may have a plurality of semicircular shapes, quadrangular shapes, polygonal shapes, etc.

In this exemplary embodiment, an adhesive 120 such as a frit is interposed between the first and second substrates 100 and 200 to combine the first substrate 100 with the second substrate 200. The frit is a mixture of glass and metal, and a melting point of the frit is lower than pure glass. The adhesive 120 is prepared on peripheral portions of the first and second substrates 100 and 200, and the adhesive 120 is fired and solidified. In this exemplary embodiment, the adhesive 120 is not in the space dividing portions 220. The space dividing portions 220 are combined with the first substrate 100 by a pressure difference between the discharge spaces 110 and outside of the light source 1000. In particular, the first substrate 100 is combined with the second substrate 200, and air between the first and second substrates 100 and 200 is discharged so that the discharge spaces 110 are evacuated. A discharge gas is injected into the evacuated discharge spaces 110. In this exemplary embodiment, a pressure of the discharge gas in the discharge spaces 110 is about 50 Torr, and an atmospheric pressure outside of the light source 1000 is about 760 Torr, thereby forming the pressure difference. Therefore, the space dividing portions 220 can be combined with the first substrate 100.

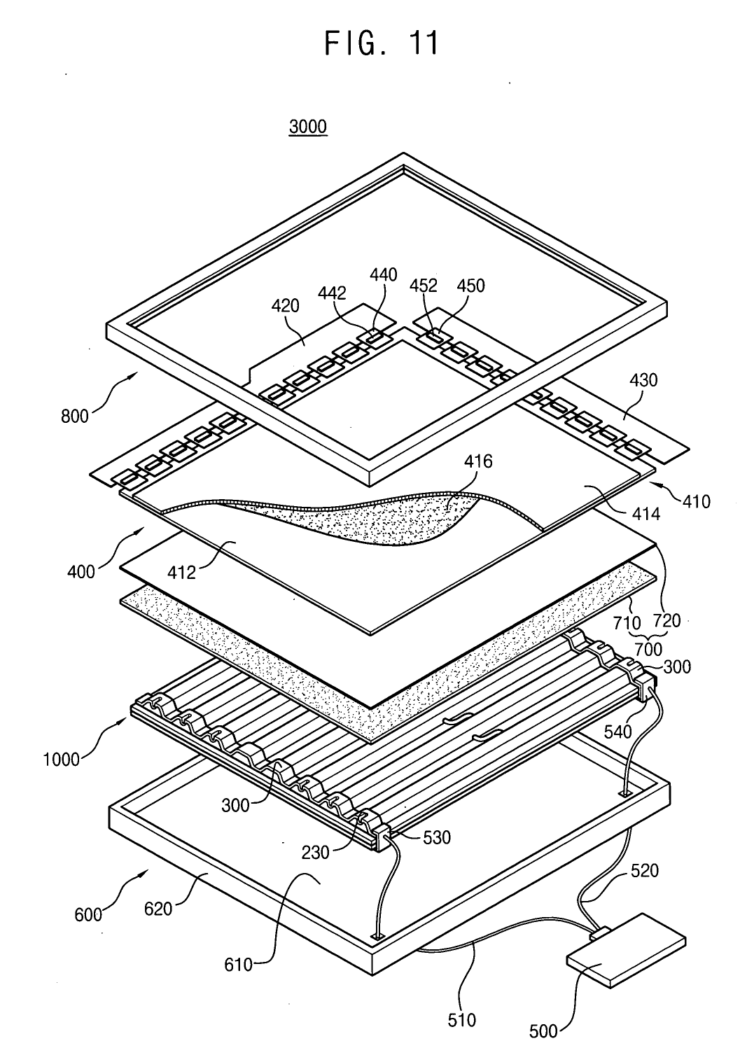

The first external electrode 300 is positioned on the second substrate 200. In this exemplary embodiment, as shown in FIGS. 1 and 11, the light source 1000 includes two first external electrodes 300 that are on opposite end portions of the second substrate 200. The first external electrodes 300 are extended in a direction that is substantially perpendicular to a longitudinal direction of the discharge space portions 210 so that each of the first external electrodes 300 partially overlap the discharge space portions 210. In this exemplary embodiment, referring to FIGS. 1 and 3, the light source 1000 further includes two second external electrodes 310 that are positioned on the first substrate 100 and correspond to the first external electrodes 300. Each of the first and second external electrodes 300 and 310 includes a band shape having a uniform electrode width EW.

In this exemplary embodiment, metal powder is coated on the first and second substrates 100 and 200 to form the first and second external electrodes 300 and 310. The metal powder may include copper (Cu), nickel (Ni), silver (Ag), gold (Au), aluminum (Al), chromium (Cr), etc. In particular, a mask having openings through which the end portions of the first and second substrates 100 and 200 are exposed is prepared on the first and second substrates 100 and 200. The metal powder is coated on the first and second substrates 100 and 200 that are partially covered by the mask. The mask is then removed from the first and second substrates 100 and 200 to form the first and second external electrodes 300 and 310. Alternatively, an aluminum tape or a silver paste may be attached to the first and second substrates 100 and 200 to form the first and second external electrodes 300 and 310. The first and second external electrodes 300 and 310 may include a transparent conductive material such as indium tin oxide (ITO), indium zinc oxide (IZO), etc. When the first and second external electrodes 300 and 310 include the transparent conductive material, an effective light emitting area of the light source 1000 is increased, and an area of each of the first and second external electrodes 300 and 310 may be also increased.

A discharge voltage that is provided from an exterior to the light source 1000 is applied to the first and second external electrodes 300 and 310 to generate plasma discharge in the discharge spaces 110.

The light source 1000 further includes a first fluorescent layer 130, a reflecting layer 150 and a second fluorescent layer 140. The first fluorescent layer 130 is positioned in the discharge spaces 110 on the first substrate 100. The second fluorescent layer 140 is positioned in the discharge spaces 110 on the second substrate 200. When an ultraviolet light generated by the plasma discharge is irradiated onto the first and second fluorescent layers 130 and 140, excitons are generated in the first and second fluorescent layers 130 and 140. When an energy level of the excitons decreases, the first and second fluorescent layers 130 and 140 emit a visible light. The reflecting layer 150 is positioned between the first fluorescent layer 130 and the first substrate 100. A portion of the visible light is reflected from the reflecting layer 150 toward the second substrate 200 to prevent a light leakage of the visible light through the first substrate 100.

The light source 1000 may further include a protecting layer (not shown) between the second substrate 200 and the second fluorescent layer 140 and/or a protecting layer (not shown) between the first substrate 100 and the reflecting layer 150. The protecting layer (not shown) prevents a chemical reaction between the first or second substrate 100 or 200 and mercury of the discharge gas, thereby preventing a loss of the mercury and a black spot on the first or second substrate 100 or 200.

The light source 1000 further includes connecting passages 240. Each of the connecting passages 240 connects the discharge spaces 110 adjacent to each other. At least one connecting passage 240 is formed on each of the space dividing portions 220. Each of the connecting passages 240 is spaced apart from the first substrate 100 by a predetermined distance. The connecting passages 240 may be formed through the molding process for forming the second substrate 200. The discharge gas that is injected into one of the discharge spaces 110 may pass through the connecting passage 240 so that pressure in the discharge spaces 110 is substantially equal.

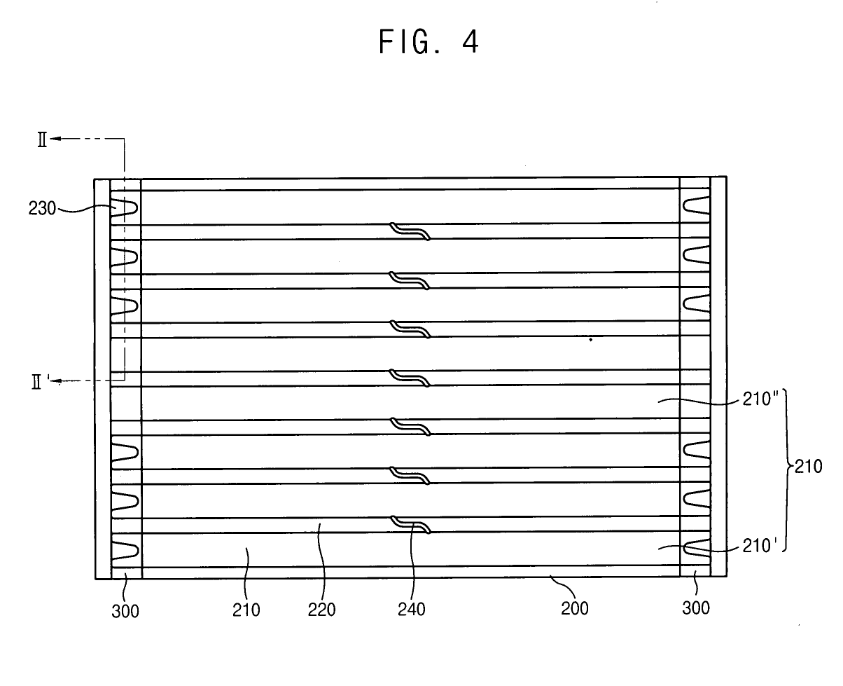

FIG. 4 is a plan view showing the light source of FIG. 1.

Referring to FIG. 4, the light source 1000 includes a plurality of luminance increasing parts 230. The luminance increasing parts 230 are formed on outermost discharge space portions 210′. Alternatively, the light source 1000 may include one luminance increasing part. In this exemplary embodiment, the luminance increasing parts 230 are formed on end portions of each of the discharge space portions 210.

When the amount of the current that flows through each of the discharge spaces 110 increases, luminance of the light generated from each of the discharge spaces 110 is increased. The amount of the current is determined by a capacitance of each of the discharge spaces 110 between the first and second external electrodes 300 and 310. The capacitance of each of the discharge spaces 110 is determined by the area between the discharge space 110 and the first and second external electrodes 300 and 310 and a distance between the discharge space 110 and the first and second external electrodes 300 and 310.

In this exemplary embodiment, each of the luminance increasing parts 230 is a recess that is recessed toward the first substrate 100. The luminance increasing part 230 is formed through the molding process for forming the second substrate 200. A portion of the second substrate 200 corresponding to the luminance increasing part 230 is thinner than a remaining portion of the second substrate 200. When the luminance increasing part 230 is formed on the outer discharge portions 210′, the surface area of the discharge spaces 110 corresponding to the outer discharge space portions 210′ and the distance between the discharge space 110 and the first and second external electrodes 300 and 310 are increased. Therefore, the capacitance of the discharge space 110 is increased, and an impedance of the discharge space 110 is decreased. As a result, the amount of the current that flows through the discharge space 110 is increased.

The number of the discharge spaces 110 and the number of the luminance increasing parts 230 are determined by the size and electrical characteristics of the light source 1000.

In this exemplary embodiment, the light source 1000 includes eight discharge space portions 210. Six of the discharge space portions 210 are the outer discharge space portions 210′, and the remaining two of the discharge space portions 210 are the central discharge space portions 210″. The outer discharge space portions 210′ are formed adjacent to an upper side and a lower side of the second substrate 200. The luminance increasing parts 230 are the recesses formed on the outer discharge space portions 210′. When a distance between a side of the second substrate 200 and each of the luminance increasing parts 230 increases, a depth of each of the luminance increasing parts 230 is decreased.

When the size of the light source 1000 increases, the number of the discharge spaces 110 is increased. The discharge spaces 110 corresponding to the central discharge space portions 210″ have uniform luminance. The luminance of the discharge spaces 110 corresponding to the outer discharge space portions 210′ is compensated by the luminance increasing parts 230. Therefore, the discharge spaces 110 corresponding to the outer discharge space portions 210′ also have the uniform luminance.

Alternatively, the luminance increasing parts 230 may be formed on two outer discharge space portions 210′ that are adjacent to the sides of the second substrate 200. The luminance increasing parts 230 may also be formed on all of the discharge space portions 210. When the luminance increasing parts 230 are formed on all of the discharge space portions 210, a size of each of the luminance increasing parts 230 decreases as the distance from the sides of the second substrate 200 increases.

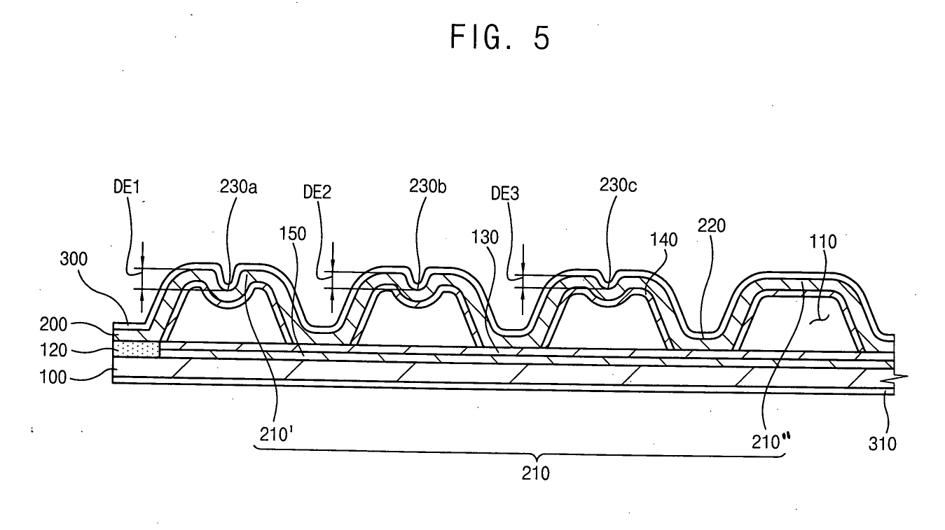

FIG. 5 is a cross-sectional view taken along a line II-II′ of FIG. 4.

Referring to FIG. 5, the luminance increasing parts 230 are formed on three outer discharge space portions 210′ that are adjacent to an upper side of the second substrate 200. The size of the luminance increasing parts 230 decreases as the distance from the upper side of the second substrate 200 increases. In particular, a first luminance increasing part 230a that is formed on an outermost discharge space portion of the outer discharge space portions 210′ has a first depth DE1. A second luminance increasing part 230b that is formed on a second outer discharge space portion next to the outermost discharge space portion has a second depth DE2 that is shorter than the first depth DE1. A third luminance increasing part 230c that is formed on a third outer discharge space portion next to the second outer discharge space portion has a third depth DE3 that is shorter than the second depth DE2. When the depth DE of the luminance increasing part 230 increases, a contact area between the first external electrode 300 and the second substrate 200 is increased, to thereby uniformize the luminance of the light source 1000.

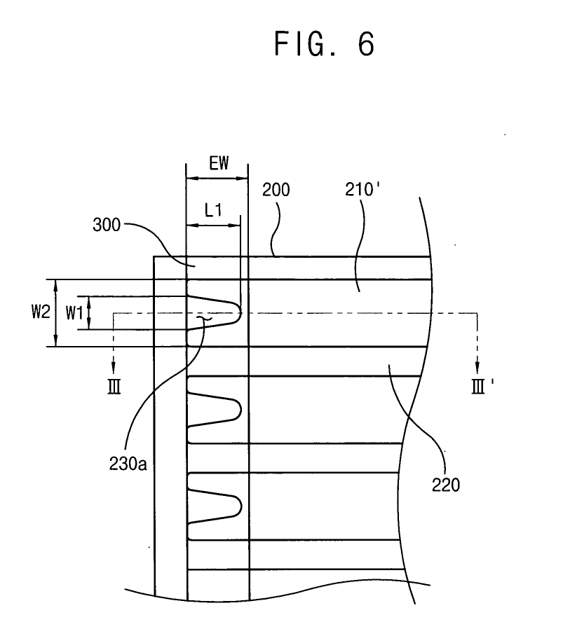

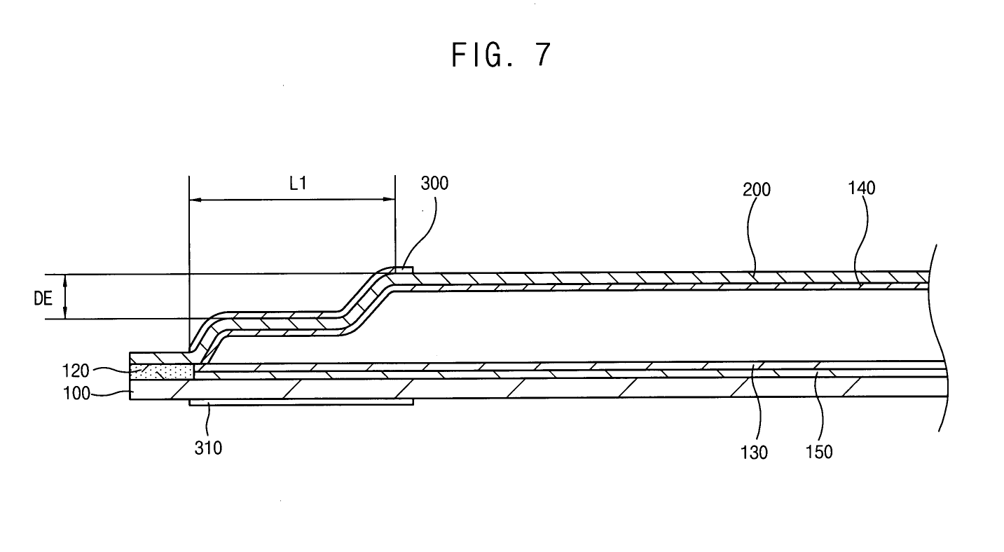

FIG. 6 is an enlarged plan view showing a recess of FIG. 4. FIG. 7 is a cross-sectional view showing a line III-III′ of FIG. 6.

Referring to FIGS. 6 and 7, the first luminance increasing part 230a has a first width W1 that is shorter than a second width of the outer discharge space portions 210 and a first length L1 that is shorter than the width EW of the first external electrode 300.

The first width W1 is shorter than the second width W2 so that the area between the first external electrode 300 and the second substrate 200 (which is between the first external electrode 300 and the discharge spaces 110) is increased by the first luminance increasing part 230a. The luminance increasing parts 230 have different widths with respect to each other. Alternatively, the luminance increasing parts 230 may have substantially equal widths. In this exemplary embodiment, the width of each of the luminance increasing parts 230 decreases as the distance between the luminance increasing part 230 and the upper side of the second substrate 200 increases.

The luminance increasing parts 230 have different lengths with respect to each other. Alternatively, the luminance increasing parts 230 may have substantially equal lengths. In this exemplary embodiment, the length of each of the luminance increasing parts 230 decreases as the distance between the luminance increasing part 230 and the upper side of the second substrate 200 increases.

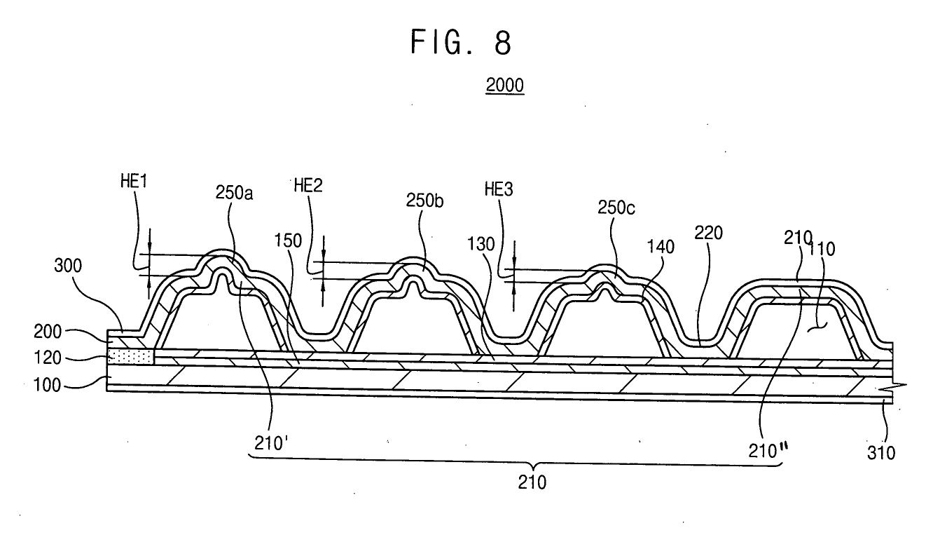

FIG. 8 is a cross-sectional view showing a light source in accordance with another exemplary embodiment of the present invention. The light source of FIG. 8 is same as in FIGS. 1 to 7 except with respect to the luminance increasing part. Thus, the same reference numerals will be used to refer to the same or like parts as those described in FIGS. 1 to 7 and any further explanation will be omitted.

Referring to FIG. 8, the light source 2000 includes a plurality of luminance increasing parts 250. In this exemplary embodiment, each of the luminance increasing parts 250 is a protrusion that is protruded from a second substrate 200.

The luminance increasing parts 250 are on end portions of each of outer discharge space portions 210′. In this exemplary embodiment, the number of the outer discharge space portions 210′ is six. Three outer discharge space portions 210′ are adjacent to an upper side of the second substrate 200, and remaining three outer discharge space portions 210′ are adjacent to a lower side of the second substrate 200. A height of each of the luminance increasing parts 250 decreases as a distance from a side of the second substrate 200 increases.

For example, a first luminance increasing part 250a that is formed on an outermost discharge space portion of the outer discharge space portions 210′ has a first height HE1. A second luminance increasing part 250b that is formed on a second outer discharge space portion next to the outermost discharge space portion has a second height HE2 that is shorter than the first height HE1. A third luminance increasing part 250c that is formed on a third outer discharge space portion next to the second outer discharge space portion has a third height HE3 that is shorter than the second height HE2. When the height of the luminance increasing part 250 increases, a contact area between the first external electrode 300 and the second substrate 200 is increased to uniformize the luminance of the light source 2000.

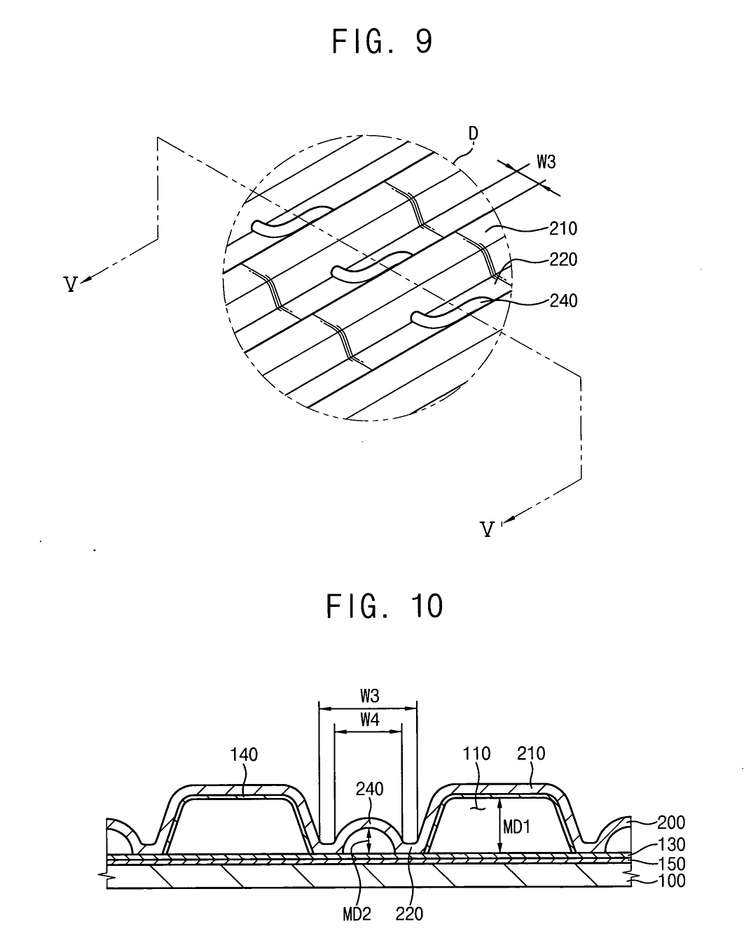

FIG. 9 is an enlarged perspective view showing a portion D of FIG. 1. FIG. 10 is a cross-sectional view taken along a line V-V′ of FIG. 9.

Referring to FIGS. 9 and 10, at least one connecting passage 240 is formed on each of the space dividing portions 220.

Each of the connecting passages 240 connects adjacent discharge spaces 110. At least one connecting passage 240 is formed on each of the space dividing portions 220. Each of the connecting passages 240 is spaced apart from a first substrate 100 by a predetermined distance. In this exemplary embodiment, the connecting passages 240 are arranged in a diagonal direction with respect to the second substrate 200, and have a curved shape or an S-shape. A length of each of the connecting passages 240 is longer than an interval between adjacent discharge spaces 110. When the length of each of the connecting passages 240 increases, a current that may flow between the adjacent discharge spaces 110 decreases to uniformize a luminance of the light source 1000.

In this exemplary embodiment, each of the connecting passages 240 is formed on a central portion of each of the space dividing portions 220. A width W4 of each of the connecting passages 240 is shorter than a width W3 of each of the space dividing portions 220. A second height MD2 of each of the connecting passages 240 is shorter than a first height MD1 of each of the discharge space portions 210. For example, the width W4 of each of the connecting passages 240 is about 1 mm to about 3 mm, and the second height MD2 of each of the connecting passages 240 is about 1 mm to about 2 mm.

Therefore, the discharge gas that is injected into one of the discharge spaces 110 may pass through the connecting passage 240 so that pressure in each of the discharge spaces 110 is substantially equal with respect to each other.

FIG. 11 is an exploded perspective view showing a liquid crystal display (LCD) device in accordance with an exemplary embodiment of the present invention. A light source of FIG. 11 is the same as previously described. Thus, the same reference numerals will be used to refer to the same or like parts as those described in FIGS. 1 to 10 and any further explanation will be omitted.

Referring to FIG. 11, the LCD device 3000 includes a light source 1000, a display unit 400 and an inverter 500.

The light source 1000 includes a first substrate 100, a second substrate 200, a first external electrode 300 and luminance increasing parts 230. The first substrate 100 has a flat quadrangular shape. The second substrate 200 is combined with the first substrate 100 to form a plurality of discharge spaces 110 between the first and second substrates 100 and 200. The second substrate 200 includes a plurality of discharge space portions 210 and a plurality of space dividing portions 220. The discharge space portions 210 are spaced apart from the first substrate 100 to form the discharge spaces 110. The space dividing portions 220 are between the discharge space portions 210, and make contact with the first substrate 100. That is, each of the space dividing portions 220 is formed between the adjacent discharge space portions 210 to form each of the discharge spaces 110. Each of the luminance increasing parts 230 is a recess or a protrusion. In this exemplary embodiment, the luminance increasing parts 230 are formed on six outer discharge space portions 210′. Three of the outer discharge space portions 210′ are adjacent to an upper side of the second substrate 200. The remaining three of the outer discharge space portions 210′ are adjacent to a lower side of the second substrate 200. An area of each of the luminance increasing parts 230 decreases as a distance from one of the upper and lower sides of the second substrate 200 increases.

The display unit 400 includes an LCD panel 410 for displaying an image, a data printed circuit board 420 and a gate printed circuit board 430. The data and gate printed circuit boards 420 and 430 apply driving signals to the LCD panel 410 through a data flexible circuit film 440 and a gate flexible circuit film 450, respectively. Each of the data and gate flexible circuit films 440 and 450 may be a tape carrier package (TCP) or a chip on film (COF). The data and gate flexible circuit films 440 and 450 include a data driving chip 442 and a gate driving chip 452, respectively. The data and gate driving chips 442 and 452 apply the driving signals to the LCD panel 410 at a predetermined timing, respectively.

The LCD panel 410 includes a thin film transistor (TFT) substrate 412, a color filter substrate 414 and liquid crystal 416. The color filter substrate 414 is combined with the TFT substrate 412. The liquid crystal 416 is interposed between the TFT substrate 412 and the color filter substrate 414.

The TFT substrate 412 is a transparent glass substrate. A plurality of switching elements (not shown) is arranged on the glass substrate in a matrix shape. In this exemplary embodiment, each of the switching elements (not shown) is a TFT. A data line that is on the glass substrate is electrically connected to a source electrode of each of the TFTs. A gate line that is on the glass substrate is electrically connected to a gate electrode of each of the TFTs. A pixel electrode (not shown) that includes a transparent conductive material is electrically connected to a drain electrode of each of the TFTs.

The color filter substrate 414 includes red, green and blue (RGB) color filters (not shown) that have a thin film shape. A common electrode (not shown) that includes transparent conductive material is formed on the RGB color filters (not shown).

When electric power is applied to the gate electrode of each of the TFTs so that the TFT is turned on, an electric field is formed between the pixel electrode (not shown) and the common electrode (not shown). Therefore, an arrangement of the liquid crystal 416 between the TFT substrate 412 and the color filter 414 is changed by the electric field applied to the liquid crystal 416 so that a light transmittance of the liquid crystal 416 is changed to display the image having a predetermined gray-scale.

The inverter 500 generates a discharge voltage to drive the light source 1000. The inverter 500 elevates a level of a voltage that is provided from an exterior to the inverter 500 to drive the light source 1000. The discharge voltage is applied to the first external electrodes 300 and second external electrodes 310 of the light source 1000 through a first power supply line 510 and a second power supply line 520. In this exemplary embodiment, the first and second external electrodes 300 and 310 are on the first and second substrates 100 and 200, respectively, and a first conductive clip 530 and a second conductive clip 540 are electrically connected to the first and second power supply lines 510 and 520, respectively. Each of the first and second conductive clips 530 and 540 electrically connects the first and second external electrodes 300 and 310.

The LCD device 3000 further includes a receiving container 600, an optical member 700 and a fixing member 800. The receiving container 600 receives the light source 1000. The optical member 700 improves optical characteristics of a light generated from the light source 1000. The fixing member 800 fixes the LCD panel 410.

The receiving container 600 includes a bottom plate 610 and a plurality of sidewalls 620 that are protruded from sides of the bottom plate 610. The light source 1000 is received on the bottom plate 610. The sidewalls 620 are substantially perpendicular to the bottom plate 610. The receiving container 600 may further include an insulating member (not shown) for electrically insulating the bottom plate 610 and the sidewalls 620 from the light source 1000.

The optical member 700 is between the light source 1000 and the LCD panel 410. The optical member 700 guides the light generated from the light source 1000. The optical member 700 may uniformize a luminance of the light. The optical member 700 may also improve a luminance when the display is viewed from in front of the LCD panel 410. The optical member 700 includes a diffusion plate 710 to diffuse the light generated from the light source 1000. The diffusion plate 710 has a plate or flat shape, and the diffusion plate 710 is spaced apart from the light source. The optical member 700 may further include a brightness enhance film (BEF) 720 on the diffusion plate 710. The BEF 720 guides the light that has passed through the diffusion plate 710 in a direction that is substantially perpendicular to the LCD panel 410 so that the luminance when viewed from in front of the LCD panel 410 is increased. Alternatively, the optical member 700 may further include a diffusion sheet (not shown) on the BEF 720.

The fixing member 800 surrounds the LCD panel 410, and is combined with the receiving container 600 to fix the LCD panel 410 to the optical member 700. The LCD panel 410 is on the optical member 700. The fixing member 800 protects the LCD panel 410 from an impact that is provided from an exterior to the LCD panel 410, and prevents drifting of the LCD panel 410.

Alternatively, the LCD device 3000 may further include a securing member (not shown) to fix the light source 1000 and the optical member 700 to the receiving container 600, and guide the LCD panel 410.

According to the embodiments of the present invention, a luminance increasing part that may be a recess or a protrusion is formed on outer discharge space portions which are partially overlapped by a first external electrode. A contact area between the first external electrode and a second substrate is increased by the luminance increasing part. In addition, a thickness of the second substrate corresponding to the luminance increasing part decreases. That is, a distance between the first external electrode and a discharge space decreases so that a luminance of the light generated from the discharge space corresponding to the outer discharge space portion is increased. Therefore, the luminance of the light is uniformized, and an image display quality of the LCD device is improved.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

1. A light source for generating a planar light comprising:
a first substrate having a flat shape; and
a second substrate including a plurality of discharge space portions, a plurality of space dividing portions and a plurality of recesses formed on a predetermined number of the plurality of discharge space portions, wherein the discharge space portions are spaced apart from the first substrate to form a plurality of discharge spaces, and the space dividing portions contact the first substrate between the discharge space portions.

2. The light source of claim 1, wherein a width of each of the recesses is shorter than a width of the discharge space portions.

3. The light source of claim 1, wherein the recesses are formed on outer discharge space portions adjacent to a first side and a second side of the second substrate, and a number of the discharge space portions adjacent to one of the first side and the second side is no more than three.

4. The light source of claim 3, wherein a depth of each of the recesses decreases as a distance from the first or second side increases.

5. The light source of claim 3, wherein the first and second sides are upper and lower sides of the second substrate, respectively.

6. The light source of claim 1, wherein the recesses are on end portions of outermost discharge space portions.

7. The light source of claim 1, further comprising a first external electrode formed on the second substrate, wherein the first external electrode is extended in a direction substantially perpendicular to a longitudinal direction of the discharge space portions, and overlaps end portions of the discharge space portions and the recesses.

8. The light source of claim 7, wherein the first external electrode has a uniform width.

9. The light source of claim 7, wherein each of the space dividing portions comprises at least one connecting passage for connecting adjacent discharge spaces, and each connecting passage is spaced apart from the first substrate.

10. The light source of claim 7, further comprising a second external electrode on the first substrate, wherein the second external electrode corresponds to the first external electrode.

11. The light source of claim 1, further comprising a fluorescent layer formed on each of the first and second substrates; and
a reflecting layer formed on the first substrate.

12. The light source of claim 1, wherein the recesses are formed on end portions of the predetermined number of discharge space portions.

13. A light source for generating a planar light comprising:
a first substrate having a flat shape; and
a second substrate including a plurality of discharge space portions, a plurality of space dividing portions and a plurality of protrusions formed on a predetermined number of the plurality of discharge space portions, wherein the discharge space portions are spaced apart from the first substrate to form a plurality of discharge spaces, and the space dividing portions contact the first substrate between the discharge space portions.

14. The light source of claim 13, wherein the protrusions are formed on outer discharge space portions adjacent to a first side and a second side of the second substrate, and a number of the discharge space portions adjacent to one of the first side and the second side is no more than three.

15. The light source of claim 14, wherein a height of each of the protrusions decreases as a distance from the first or second side increases.

16. The light source of claim 14, wherein the first and second sides are upper and lower sides of the second substrate, respectively.

17. The light source of claim 13, wherein each of the space dividing portions comprises at least one connecting passage for connecting adjacent discharge spaces, and each connecting passage is spaced apart from the first substrate.

18. The light source of claim 13, further comprising a first external electrode formed on the second substrate, wherein the first external electrode is extended in a direction substantially perpendicular to a longitudinal direction of the discharge space portions, and overlaps end portions of the discharge space portions and the protrusions.

19. The light source of claim 18, further comprising a second external electrode on the first substrate, wherein the second external electrode corresponds to the first external electrode.

20. The light source of claim 13, wherein the protrusions are formed on end portions of the predetermined number of discharge space portions.

21. A liquid crystal display device comprising:
a light source for generating a planar light, the light source including:
a first substrate having a flat shape;
a second substrate having a plurality of discharge space portions, a plurality of space dividing portions and a plurality of luminance increasing parts formed on end portions of a predetermined number of the plurality of discharge space portions, wherein the discharge space portions are spaced apart from the first substrate to form a plurality of discharge spaces, and the space dividing portions contact the first substrate between the discharge space portions; and
a first external electrode formed on the second substrate, wherein the first external electrode is extended in a direction substantially perpendicular to a longitudinal direction of the discharge space portions, and overlaps the end portions of the discharge space portions and the luminance increasing parts;
the liquid crystal display device further comprising:
a liquid crystal display panel for displaying an image using the planar light generated from the light source; and
an inverter for applying a discharge voltage to the first external electrode.

22. The liquid crystal display device of claim 21, wherein the luminance increasing parts comprise recesses that are recessed toward the first substrate.

23. The liquid crystal display device of claim 21, wherein the luminance increasing parts comprise protrusions that are protruded from the second substrate.

24. The liquid crystal display device of claim 21, wherein the luminance increasing parts are formed on outer discharge space portions adjacent to a first side and a second side of the second substrate, and a number of the discharge space portions adjacent to one of the first side and the second side is no more than three.

25. The liquid crystal display device of claim 24, wherein an area of each of the luminance increasing parts decreases as a distance from the first or second side increases.

26. The light source of claim 24, wherein the first and second sides are upper and lower sides of the second substrate, respectively.

27. The liquid crystal display device of claim 21, wherein each of the space dividing portions comprises at least one connecting passage for connecting adjacent discharge spaces, and each connecting passage is spaced apart from the first substrate.

28. The liquid crystal display device of claim 21, further comprising a second external electrode on the first substrate, wherein the second external electrode corresponds to the first external electrode.

29. The liquid crystal display device of claim 21, further comprising:
a receiving container for receiving the light source;
an optical member positioned between the light source and the liquid crystal display panel; and
a fixing member for fixing the liquid crystal display panel to the receiving container.

30. The liquid crystal display device of claim 29, wherein the optical member comprises:
a diffusion plate spaced apart from the light source by a predetermined distance for diffusing visible light generated from the light source; and
a brightness enhancement film for guiding the visible light that has passed through the diffusion plate toward the liquid crystal display panel.
